(19) United States
(12) Patent Application Publication
(10) Pub. No.: US 2022/0358456 A1
(43) Pub. Date: Nov. 10, 2022

(54) CATEGORIZATION OF ITEMS FOR DELIVERY SERVICE

(71) Applicant: Uber Technologies, Inc., San Francisco, CA (US)

(72) Inventors: Nicole Rafidi, Huntington, NY (US); Peter Tran, San Francisco, CA (US); Longfei Xing, New York, NY (US); Sze Yick, San Francisco, CA (US)

(21) Appl. No.: 17/736,642

(22) Filed: May 4, 2022

Related U.S. Application Data
(60) Provisional application No. 63/183,896, filed on May 4, 2021.

(51) Int. Cl. G06Q 10/08; G06N 20/00

(52) U.S. Cl. CPC G06Q 10/0833; G06Q 10/0832; G06Q 10/087; G06N 20/00

(57) ABSTRACT

A network computer system determines a category of at least a first item of the order request, where the category is determined programmatically by the network computer system based at least in part on a description of the first item. The network computer system further determines one or more delivery parameters for the order request based on the determined category of at least the first item. Based at least in part on the one or more delivery parameters for the order request, the network computer system implements a delivery process that includes selecting a service provider that delivers the one or more items of the order request to the delivery location.

### PRIORITY CLAIM

The present application is a continuation of U.S. Application No. 63/183,896 having a filing date of May 4, 2021. Applicant claims priority to and the benefit of each of such applications and incorporate all such applications herein by reference in its entirety.

### BACKGROUND

On-demand food delivery involves users requesting menu items from menu listings of individual restaurants participating in the on-demand food delivery platform. The users submit orders through a service application running on a user device, and the requests are received at a restaurant and fulfilled by the restaurant for pickup and delivery by a service provider that the on-demand food delivery service arranges. Restaurants set prices for the menu items, and the on-demand food delivery service handles billing the user for orders placed with the restaurants.

### BRIEF DESCRIPTION OF THE DRAWINGS

FIG. 1 illustrates a network computing system to programmatically categorize deliverable items and to configure processes that are used to deliver items based on determined categories, according to one or more examples.

FIG. 2 illustrates an example method for configuring a delivery process based on a determined categorization of one or more items of a delivery order.

FIG. 3 illustrates an example method for programmatically categorizing a deliverable item based on a supplier's description of the item.

FIG. 4 illustrates an example of a machine-learning neural network model to categorize an item based on a numeric representation of its description.

FIG. 5 illustrates an example method of training a machine-learning neural network model, such as described with FIG. 4.

FIG. 6 is a block diagram that illustrates a computer system upon which aspects described herein may be implemented.

FIG. 7 is a block diagram that illustrates a computer system upon which aspects described herein may be implemented.

### DETAILED DESCRIPTION

According to examples, a network computer system operates to provide a service in which transport is arranged to deliver requested items for requesters. The network computer system includes a categorization system that utilizes machine-learning models to categorize deliverable items available through the network computing system. The network computer system utilizes the determined categories of the deliverable items to implement different facets of a delivery service provided though the network computer system.

In examples, the network computer system categorizes deliverable items to determine those items which are properly associated with a category-specific compliance value. In some examples, the category-specific compliance value may also be specific to a geographic region of the supplier.

In some examples, a network computer system operates to receive an order request from a requester, in connection with the network computer system providing a network service to transport deliverable items to a population of users. The order request specifies one or more deliverable items provided by a supplier and a delivery location. The network computer system determines a category of at least a first item of the order request, where the category is determined programmatically by the network computer system based at least in part on a description of the first item. The network computer system further determines one or more delivery parameters for the order request based on the determined category of at least the first item. Based at least in part on the one or more delivery parameters for the order request, the network computer system implements a delivery process that includes selecting a service provider that delivers the one or more items of the order request to the delivery location.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs, or machines.

Furthermore, one or more aspects described herein may be implemented through the use of instructions that are executable by one or more processors. These instructions may be stored on a computer-readable medium. Machines shown or described with figures below provide examples of processing resources and computer-readable media on which instructions for implementing some aspects can be stored and/or executed. In particular, the numerous machines shown or described include processors and various forms of memory for storing data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices), and magnetic memory. Computers, terminals, and network-enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions, and processing is performed by interconnected gates.

### System Overview

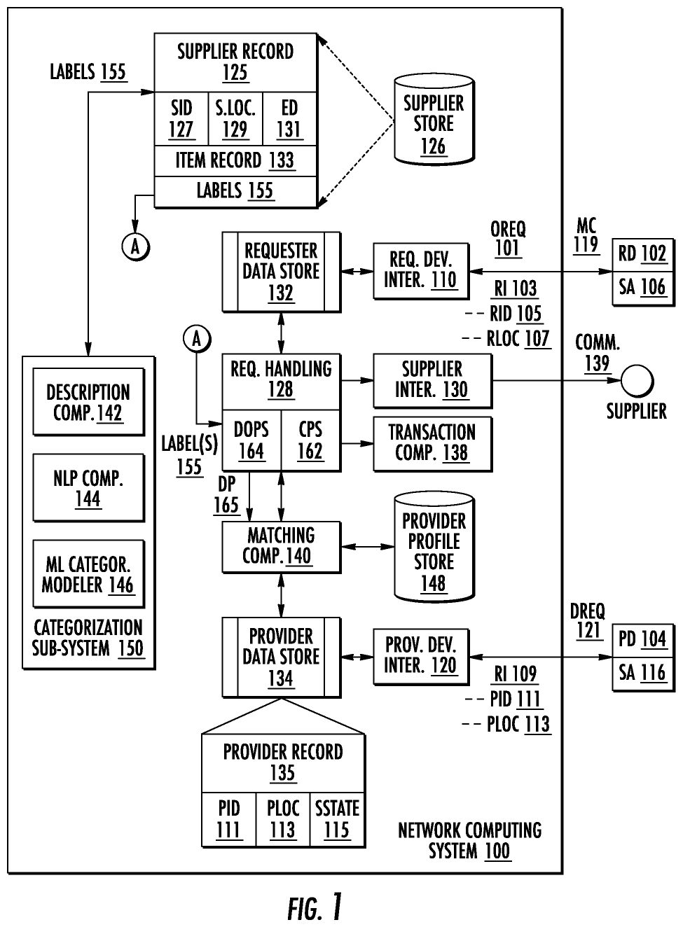

FIG. 1 illustrates a network computing system to programmatically categorize deliverable items and to configure processes that are used to deliver items based on determined categories, according to one or more examples. In examples, a network computing system 100 provides a network delivery service that can be utilized by requesters, suppliers and service providers. The network computing system 100 can be implemented on a server, on a combination of servers, and/or on a distributed set of computing devices which communicate over a network such as the Internet. Still further, some examples provide for the network computing system 100 to be distributed using one or more servers and/or mobile devices. In some variations, the network computing system 100 is implemented as part of, or in connection with a network service (e.g., “on-demand service”), where service providers use service vehicles to provide transport-related services between locations. In variations, the network computing system 100 can be implemented using mobile devices of users, including service providers and requesters, with the individual devices executing a corresponding service application that causes the computing device to operate as an information inlet and/or information outlet for the network computing system 100.

In some examples, the network computing system 100 implements a network platform, in connection with applications that run on mobile devices of the population of users. For a given geographic region, the users can include (i) operators (or “service providers”) of service vehicles, (ii) requesters who request and receive delivery orders transported by service providers, and (iii) suppliers, who prepare, gather or otherwise provide requested delivery orders for transport. While some examples describe suppliers in context of food preparation (e.g., restaurants which prepare food items based on a menu), the network computing system 100 can be implemented to arrange delivery for other kinds of deliverable items, such as food, groceries, alcohol, medicine (e.g., including OTC or prescription), convenience items, serviced items, store products, or any other kind of item that can be delivered (collectively “items”). More generally, the network computing system 100 may be implemented to arrange delivery of any type of item, including items which may require preparation by a supplier and/or gathering or selection by a service provider.

With reference to an example of FIG. 1, the network computing system 100 includes a requester device interface 110, a provider device interface 120, a request handling component 128, a supplier interface 130, a matching component 140, and one or more data stores which update information about requesters, order requests and service providers. Additionally, the network computing system 100 includes a categorization sub-system 150 that programmatically categorizes deliverable items based on descriptions provided by the respective suppliers. The network computing system 100 implements delivery services for delivery requests based on determined categorizations of individual items of the delivery request.

The requester device interface 110 includes or performs processes that run on the network-side of the network computing system 100 to establish communication channels with individual devices of requesters. The requesters may operate mobile devices (represented in FIG. 1 by the requester device 102) on which a corresponding service application 106 can execute. The requesters operate respective service applications 106 to request delivery services, and in some variations, other types of transport-related services, such as human transport between a start location (or pickup location) and a destination (or drop-off). When the service application 106 is launched on the requester device 102, the requester device 102 transmits requester information 103 to the network computing system 100. The requester information 103 can include an account identifier 105, as well as the current location 107 of the requester device 102, which the service application 106 may obtain by interfacing with a satellite receiver or other location-aware resource of the requester device 102. As described in greater detail, the requester information 103 can also be communicated with an order request 101. In some variations, at least some of the requester information 103 (e.g., current location) may be communicated before an order request 101 is made on the requester device 102.

According to some examples, the provider device 104 initiates communications with the network computing system 100 using the service application 116. The service application 116 corresponds to a program (e.g., a set of instructions or code) that is downloaded and stored on the mobile device 104 of the service provider. The service provider can launch the service application 116 in order to utilize the network computing system 100 to receive service requests, such as delivery requests 121 and transport requests. The delivery request 121 may correspond to a communication that includes or corresponds to the order request 101. The service provider can operate a service vehicle to fulfill assigned service requests. Once the communication channel is established by the provider device 104 using the service application 116, the provider device 104 repeatedly or continuously communicates services information 109 to the network computing system 100. The service information 109 includes the provider's identifier 111, and the provider's current location 113, which may be determined by the service application interfacing with a satellite receiver of the provider device 104.

The provider device interface 120 includes or performs processes that run on the network-side of the network computing system 100 to establish communication channels with individual devices of service providers. For example, the provider device interface 120 can establish secure sockets with different types of mobile devices, which service providers of the network computing system 100 can utilize when providing services using their respective vehicles. In some examples, the service providers operate mobile devices (represented in FIG. 1 by the mobile device 104) on which a corresponding service application 116 may be operated. Among other functionality, the service application 116 can automate operations which include indicating the availability of the service provider to provide service, communicate location information to enable the network computing system 100 to monitor the location of the service provider's vehicle, receive information from the network computing system 100 to facilitate the service provider in receiving order requests and fulfilling order requests, as well as communicating information to the network computing system 100 for various purposes, including provisioning determination.

The network computing system 100 includes an active provider store 134 that maintains records 135 that associate individual providers with their respective provider identifier 111, current location 113, and service status 115. By way of example, each service provider can start a shift by operating the service application 116 (e.g., opening the application on the provider's device 104), and then toggling a state feature provided by the service application 116 to ‘on duty’. The service application 116 communicates the activation of the state feature to the network computing system 100 via the provider device interface 120. The provider device interface 120 processes the service information 109 received from individual service providers. For each service provider, the provider device interface 120 extracts and stores the current location 113 of the provider device 104 with the provider's identifier 115 in the active provider store 134. As the service provider's location changes (e.g., with movement of the service provider's vehicle), subsequent communications from the provider device 104 via the provider device interface 120 can be used to update the active provider store 134. In this way, the active provider store 134 reflects the most current location of each service provider.

In some examples, the requester device interface 110 and the provider device interface 120 can each include or use an application programming interface (API), such as an externally facing API, to communicate data with the provider and requester devices 102, 104, respectively. By providing the externally facing API, the network computing system 100 can establish secure communication channels via secure access channels over the network through any number of methods, such as web-based forms, programmatic access via RESTful APIs, Simple Object Access Protocol (SOAP), remote procedure call (RPC), scripting access, etc.

According to some examples, the supplier interface 130 correspond to a programmatic interface that communicates order requests 101 to a terminal of a supplier. In the context of food delivery, the supplier interface 130 transmits delivery orders to a computer system (e.g., reservation ordering system, point-of-sale device, dedicated take-out terminal, etc.) of the supplier. In some examples, the supplier may operate a mobile device on which a service application for suppliers is provided, in order to receive order requests from the network computing system 100. The supplier may access the network computing system 100 via, for example, a website or application interface (e.g., supplier service application) in order to accept order requests, as well as to provide information as to the preparation status of an order request. Additionally, the supplier may access the network computing system 100 in order to provide menus or descriptions (including text and images) of available items for delivery.

In some examples, the provider interface 120 can receive order requests from the supplier interface 130, in place of suppliers. In such examples, a provider may be selected to prepare or gather the items of an order request 101. For example, the provider may travel to a store, select merchandise specified by the order request 101, and delivery the items of the order request 101 to the requester.

The network computing system 100 maintains a supplier store 126 that includes supplier records 125. Each supplier record 125 associates a respective supplier with an account identifier 127, a supplier location 129 and an electronic document 131 (e.g., menu, product catalog) that includes descriptions for individual items provided by that supplier. Each supplier record 125 can also be associated with item records 133 (e.g., food items, products for pickup and delivery), including the description of the respective item provided by the supplier with the electronic document 131. Further, each item record 133 can be associated with one or more labels 155 which correlate to determined categories for the associated items.

According to some examples, when the requester launches the service application 106, the requester device 102 provides the network computing system 100 with the current location 107 of the requester. In some variations, the requester can specify a service location for the delivery order that is different than the requester's current location 107. The requester device interface 110 communicates item selection content 119 (e.g., online menu of a restaurant) to the requester device 102, via the service application 106. The user can browse through the item selection content 119 in order to view a list of suppliers and/or view items which individual suppliers have available for delivery. The service application 106 enables the user to interact with an interface on the requester device 102, in order to select items for a delivery order. Upon making a selection, the service application 106 causes the requester device 102 to transmit an order request 101 to system 100. The order request 101 is received by the requester device interface 110 and recorded in a requester-status store 132. The request handling component 128 acts on the incoming order request 101, and updates the status of the order request 101 as the order request is processed. The request handling component 128 can also trigger the matching component 140 to initiate a matching process to select a service provider for the order request 101.

The matching component 140 can match parameters of the order request 101 to an available service provider. The matching parameters of the order request 101 include the location of the supplier 129 (or pickup location), the drop-off location of the order request 101, and the determined labels 155 of items of the order request 101. In examples, the matching component 140 matches the parameters of individual order request 101 to one or more service providers based at least in part on the current location 113 of the service providers. In some examples, matching component 140 determines an available set of candidate for individual service requests. The determination of candidate service providers can be based on the current location 113 of the service provider relative to the service locations (e.g., pickup location, drop-off location) of service requests, as well as the availability of the service provider (e.g., as provided by service state 115) to fulfill the service request.

According to examples, matching engine 140 implements one or more of selection criteria, weighting criteria, and/or ranking in determining a candidates set of service providers and/or selecting a service order for the order request 101. In some examples, the service provider is first invited to accept the service request before being matched to it, and the ranking of service providers amongst the candidates set can identify a sequence or priority for inviting the service providers of the candidate set.

Once the matching component 140 selects a provider for the order request 101, the request handling component 128 can monitor the provider via updates to the provider location (e.g., as maintained in the provider data store 134). In particular, the request handling component 128 can track the service provider to the location of the supplier, and from the location of the supplier to the service location of the order request 101. The status of the requester's order request is repeatedly updated by the request handling component 128 in the requester status store 132, to reflect events such as (i) communicating a delivery request 121 to the provider device 104 of the matched service provider; (ii) the supplier acknowledging the order request; (iii) one or more progress indicators for the order request being prepared, including when a corresponding delivery order is ready; (iv) a service provider picking up the corresponding delivery order; (v) progress of the service provider to the service location identified in an order request; and/or (vi) arrival of the service provider at the service location of the requester (e.g., the requester's current location, or specified location).

In examples, the request handling component 128 can also signal a transaction component 138 to charge the requester for the delivery order 121. The transaction component 138 can access, for example, a funding account or instrument of the requester for the delivery order, where the charge includes, for example, a supplier charge for the items of the delivery request and a charge for the delivery service provider by the service provider. As described with some examples, the charge to the requester can include a compliance charge (e.g., tax) for the items of the delivery order.

The matching component 140 (and/or the request handling component 128) can change the associated state 115 of the service provider, to reflect, for example, one or more availability states. For example, the states 115 of the service provider may include available, assigned to order request, on route to supplier, at supplier, on route to requester, and completing order request. Additionally, the state of the service provider can reflect that the service provider has, or is likely to have a passenger during a portion of the time in which the service provider delivers an order request 101.

### Categorization Subsystem

In examples, the categorization subsystem 150 accesses the supplier data store 126 to retrieve the electronic document 131 and/or item descriptions from the supplier store 126. The categorization subsystem 150 uses the item descriptions to determine one or more categories for individual items of the suppliers. The categorization subsystem 150 can implement a categorization process to determine one or more categories for individual items, in accordance with a predetermined schema. In variations, the categorization subsystem 150 can utilize multiple categorization processes and schemas to determine one more categories for individual items provided by suppliers of the supplier store.

In examples, the categorization subsystem 150 generates a set of labels 155 for individual items provided by suppliers. The categorization subsystem 150 can update the supplier records 125 of individual suppliers to associate labels 155 with items provided by each supplier, where the labels that are associated with individual items reflect the determined category or categories of the particular item.

In more detail, categorization subsystem 150 programmatically analyzes item descriptions (e.g., from electronic document 131 and/or item records 133) for individual suppliers using machine-learning processes. With reference to FIG. 1, the categorization subsystem 150 represents a specialized system or cluster of systems for efficiently executing machine-learning processes that adaptively analyze and categorize item descriptions. The categorization subsystem 150 can act as a service for the network computer system 100 to communicate with in order to create and use machine-learning models. The categorization subsystem 150 can use specialized hardware such as graphics processing units to more efficiently implement the machine-learning models.

In some aspects, a description component 142 obtains raw text from descriptions of items stored with the records 125 of the supplier store 126. In the context of a restaurant menu, the raw text can include a supplier-provided name of the food item (e.g., burger, “The Classic”, etc.), as well as a description of the food item (e.g., “100% grass-fed beef with all the fixings.”). The raw text can also include a contextual descriptor that applies to multiple items of the menu or catalog. For example, the contextual descriptor for a menu may correspond to “breakfast”, “entree” or “sides”.

The description component 142 tokenizes the raw text to generate a list of descriptive words, where the list disregards grammar and word order but retaining multiplicity. Thus, any word that appears multiple times in the text may have more than one entry in the list of descriptive words.

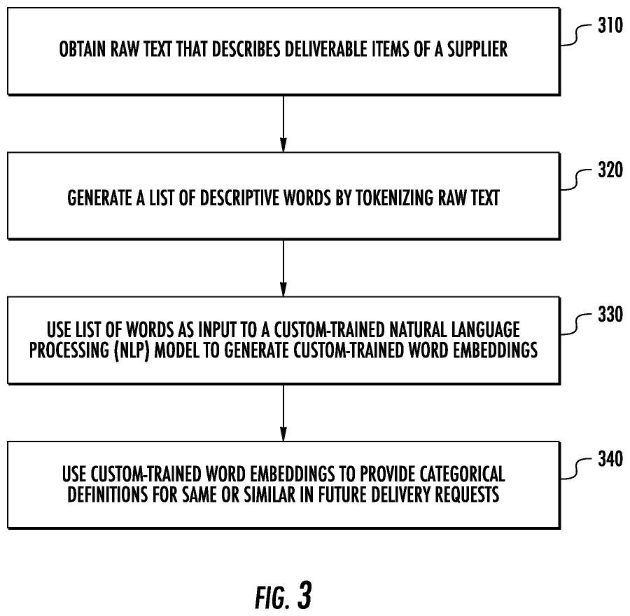

In some aspects, the description component 142 further compares each of the word tokens to a list of stop words and removes any word tokens that are found in the list of stop words. Stop words can include common words in the language of the description, such as articles and prepositions, and any keywords that appear in the raw text of catalogued items. As shown in FIG. 3, keywords can include field names and headings such as “menu,” “name,” and “description.”

In further aspects, the description component 142 can implement internationalization aspects to parse descriptive terms from multiple languages, enabling multi-language categorization of menu items for sources in international locations. Furthermore, the description component 142 can connect international descriptive terms with English words, which may then be represented by the same or similar vectors in the machine-learning models used to classify the items.

In one aspect, the categorization subsystem 150 implements a multi-step process using one or more machine-learning models to classify an item based on the list of descriptive words that the description component 142 generates.

In some examples, a natural language processing (NLP) component 144 takes as input a corpus of the item descriptions of a number of items processed by the description component 142. The natural language processor 144 produces a vector space, typically of several hundred dimensions, with each unique word in the corpus being assigned a corresponding vector in the space. Word vectors are positioned in the vector space such that words that share common contexts in the corpus are located close to one another in the space. In the context of restaurants, items across menus for restaurants participating in the service offered by the network platform can be used as the corpus for training input for the NLP model to generate and update the vector space.

To generate custom-trained word embeddings for a given item, each word in the list of descriptive words for that item is matched to its corresponding vector in the NLP model, and the resulting vectors are combined (e.g., by averaging values at each index). The resulting custom-trained word embedding is a single vector numeric representation of the description of the item.

As an addition or variation, a machine-learning (ML) categorization modeler 146 takes the custom-trained word embeddings for an item as input to a neural network trained on word embeddings for items in the item records database 120.

The output of the neural network can correspond to a set of probabilities that represent the likelihood of the item belonging to each of the categories. The categorization subsystem 150 can utilize one or multiple categorization schemas for determining categories for items. For example, the categorization subsystem 150 can utilize a categorization schema that includes category labels which are predetermined to potentially configure or otherwise impact a delivery process. In other examples, the ML categorization modeler 146 can utilize a categorization schema that is based on potential food allergens, adherence to dietary restrictions, or other useful classifications. As an addition or variation, the ML categorization modeler 146 can utilize a categorization schema that identifies tax categories, based on definitions provided by tax laws of cities, counties, states, territories or countries.

In some implementations, the ML categorization modeler 146 can input the data generated by the description component 142 so as to predict a tax categorization to associate with each food item stored with the records 125 of the supplier store 126. For example, a new menu associated with a restaurant can be uploaded, which can be analyzed by the description component 142. The output generated by the description component 142 can be input into the ML categorization modeler 146. Based on the generated description component 142, the ML categorization modeler 146 can automatically predict tax categorizations for all the new menu items. By way of example, the ML categorization modeler 146 can predict that a particular menu item includes dairy or alcohol. The ML categorization modeler 146 can associate the dairy item with a tax category associated with dairy products and the alcohol item with a tax category associated with alcohol products.

In some implementations, the ML categorization modeler 146 can additionally input the location 129 of the supplier when predicting the tax categorizations for all the new menu items. For example, the ML categorization modeler 146 can take into account language and vernacular that may be specific to the region that the supplier is located in so as to provide more accurate tax categorization predictions. The location 129 of the supplier can be taken into account when determining what tax to apply to particular goods based on the predicted tax categorization due to different applications of taxes based on the location of the provider. For instance, the computing system 100 can apply varying taxes on individual menu or inventory items based at least in part on a combination of the predicted tax categorization and the location of the provider of the menu item. Thus, the computing system 100 can apply taxes in accordance with the applicable tax laws.

In some implementations, the ML categorization modeler 146 can generate subcategories for particular items. For instance, the ML categorization modeler 146 can be trained (e.g., using labelled training data and supervised learning techniques) to generate a plurality of subcategories that are relevant to a particular class of item. The subcategory can provide a further descriptor (in the form of metadata) about the item including, for example, a typical/intended use, a source, a restriction indicator, a season, a region, etc. By way of example, the ML categorization modeler 146 can generate subcategories for medicine associated with particular uses or ingredients as well as based on whether a medicine is over the counter or prescribed.

In some implementations, the ML categorization modeler 146 can be trained based on labelled data. In particular, labelled data can include items being associated with particular categorizations. As a particular example, milk (and any item containing dairy) can be associated with tax category 1 while soda can be associated with tax category 2. Even more particularly, the tax categories associated with items can be based at least in part on the region of the item location (e.g., tax jurisdiction). Furthermore, the ML categorization modeler 146 can be trained based on region specific nomenclature. For example, items may be associated with the nomenclature “chips” in certain regions and as “crisps” in others.

In some implementations, the ML categorization modeler 146 can generate multiple categorizations for each item. An individual item can be associated with multiple categorizations associated with multiple components that the item is comprised of. For example, the ML categorization modeler 146 can generate multiple categorizations for an alcohol-based candy (e.g., alcohol, sugar, etc.). As additional example, the ML categorization modeler 146 may generate multiple categorizations for ice cream (e.g., dairy, sugar, fat content, etc.). Data used to train ML categorization modeler 146 can include labels associating certain items with more than one categories. Additionally, or alternatively, the training data can include categories labels for particular components of items (e.g., ingredients, etc.) to train the ML categorization modeler 146 to associated certain items with more than category (or subcategory) based on the components of the items.

In some implementations, items can be associated with state specific categorizations and federal specific categorizations. By way of example, the ML categorization modeler 146 can be configured to generate state tax categories for a particular item (e.g., by training the ML categorization modeler 146 based on state tax classification data) and/or to generate federal tax categories for a particular item (e.g., by training the ML categorization modeler 146 based on federal tax classification data).

In some implementations, the categorization schema can include categories that match the classification categories used by a compliance calculation service. In particular, a tax category can be sent to another system (e.g., a taxation system) for automated reporting. As a particular example, a taxation system can allow an entity to get a report at a later time. By way of example, supplier (e.g., a store, restaurant, etc.) can use a computing system to access the taxation system and access the report at a later time (e.g., during a tax reporting timeframe).

In some implementations, an associated tax amount can be added to a price of a user delivery to adjust the data associated with the final price of the delivery. In particular, the associated tax amount can be based at least in part on the tax categorizations generated by the ML categorization modeler 146. For example, an associated tax amount can be found in an accessible look-up table to determine the associated tax amount for a particular item. An updated final price including the associated tax amount can be presented to the user associated with the user delivery. For example, the updated final price can be presented to the user on the user's device associated with the user delivery such that the user interface surfaces the updated final price. Alternatively, the updated final price can be presented to the supplier associated with the delivery.

In some aspects, the item is classified into the category with the highest probability value, and a label 155 representing the determined category is stored in association with the item record 133 and/or supplier record(s) 125 in the supplier store 126. In addition to storing the determined category for the item, the categorization subsystem 150 can store the raw probabilities and/or a confidence value for the determined category. The confidence value can be based on the magnitude of the highest probability value, with values near the maximum yielding high confidence and items with multiple categories of similar probability yielding a low confidence value.

In one aspect, suppliers can add items to their respective menus or catalogs through, for example, a supplier interface. The categorization subsystem 150 can implement a batch process that runs as a trigger or on a schedule, to retrieve new item information from supplier records 125 of the supplier store 126. Suppliers of the menu items can see the determined item categories for any items on their menus through the supplier interface and submit any corrections if they discover that items have been categorized incorrectly. These corrections are stored with the respective supplier and item records 125, 133 of supplier store 126 and further can be used as further training data to retrain the machine-learning models in order to improve their accuracy.

In another aspect, the ML categorization modeler 146 can flag any item with a low confidence value for its classification. For example, if an item's classification is below a threshold confidence value, the item can be flagged for a manual review process. Accordingly, the categorization subsystem 150 can display items flagged for the manual review process to one or more reviewers who are able to correct any classifications that appear to be mistakes or to confirm that the classification is correct. The manual corrections and confirmations which are stored with the supplier data store 126 can be used as training data to tune and/or retrain the ML models in use to improve their accuracy.

In some implementations, the ML categorization modeler 146 can generate categorization predictions for items for applications related to advertisement. For instance, by categorizing items by the ML categorization modeler 146, the computing system 100 can surface better targeted advertisements to users based on historical user data in order to provide a better customer experience.

Additionally, or alternatively, the ML categorization modeler 146 can generate categorization predictions for items for applications related to regulatory purposes. For instance, the ML categorization modeler 146 can generate predicted categorizations of materials associated with the items. As one particular example, the ML categorization modeler 146 can generate predicted categorizations of materials associated with the packaging of particular items.

In some implementations, the predicted categorizations generated by the ML categorization model 146 can be used to apply discounts based on a category of an item. For instance, if there is a surplus of a particular component, the computing system 100 can apply a discount to items associated with the surplus component based on the predicted categorizations generated by the ML categorization model 146. In particular, the computing system 100 can transmit a pricing adjustment recommendation to a supplier based at least in part the output of the ML categorization model 146 being associated with a component surplus or a component shortage. Additionally, or alternatively, the computing system 100 can initiate a pricing promotion within the computing system 100 on items containing the surplus component. In particular, the user interface of the computing system 100 can be adjusted so as to reflect a new promotion on items containing the surplus component. For example, the user interface of the computing system 100 can surface a notification to users indicating that a new promotion is going into effect. As another example, the user interface of the computing system 100 can surface indicators associated with individual items that are a part of the promotion so as to indicate to a user which items are a part of the promotion. In some implementations, a notification can be interactive such that, for example, a user can interact with the notification to cause an action (e.g., the launch of a software application and/or interface to order one or more of the items included in the promotion).

In some implementations, the predicted categorizations generated by the ML categorization model 146 can be associated with a broader genre of the item. For example, the predicted categorizations generated by the ML categorization model 146 can be associated with a specific culinary genre (e.g., Mexican, Chinese, Italian, etc.). The computing system 100 can provide (e.g., to a user device of the user) a more accurate filtered feed including specific culinary genres. The specific culinary genres can be based at least in part on sorting providers using the predicted categorizations associated with the items the providers sell. For example, the computing system can associate a specific culinary genre with a provider when the number or proportion of items the provider sells that matches a specific culinary genre reaches a threshold value (e.g., greater than 15, 25, etc.).

In some implementations, the predicted categorizations generated by the ML categorization model 146 can be leveraged to provide allergy warnings or disclaimers to users. In some instances, the computing system can provide allergy warnings or disclaimers to users for common hazards (e.g., peanuts, shellfish, dairy, etc.) based on the predicted categorizations generated by the ML categorization model 146 associated with a particular item. Additionally, or alternatively, the computing system can provide targeted allergy warnings or disclaimers to users based on a combination of a user profile associated with the computing device and the predicted categorizations generated by the ML categorization model 146 associated with a particular item. For example, based on the predicted categorizations generated by the ML categorization model 146, the computing system 100 can surface a disclaimer that a product contains gluten to a user with a gluten intolerance. In particular, the computing system 100 can surface targeted allergy warnings or disclaimers to users based at least in part on a combination of the predicted categorizations generated by the ML categorization model 146 and a user profile. The user profile can be, for example, a data structure with a plurality of attributes. The plurality of attributes can be arranged in, for example, a look-up table. The predicted categorizations output by the ML categorization model 146 can be used to perform a look-up such that the computing system 100 can determine if there are any user preferences, restrictions, and/or allergies that match.

In some implementations, the computing system 100 can provide a user a customized feed of items in the user interface based on a combination of a user profile and the predicted categorizations generated by the ML categorization model 146. For instance, the computing system 100 can access a user profile associated with a user of a user device. The computing system 100 can filter out items within a particular predicted categorization generated by the ML categorization model 146 such that the user interface presents an updated feed of items not including the items which were filtered out. In particular, the updated feed of items can be a new data structure associated with the new set of data associated with the items which were not filtered out. The computing system 100 can re-weight items within a particular predicted categorization generated by the ML categorization model 146 such that the user interface presents an updated feed of items based on the weights of the items (e.g., the higher weighted items presented higher on the feed). For instance, components which a user profile indicates to avoid (e.g., based on intolerance, allergy, preference, etc.) can be re-weighted such that items including the indicated components are weighted more lightly. Furthermore, components which a user profile indicates a preference for (e.g., based on restrictions, likes, etc.) can be taken into account. For instance, the computing system 100 can re-weight items containing components that a user profile indicates a preference for to be heavier such that in an updated feed such items would be surfaced earlier. In particular, the updated feed of items can be a new data structure associated with the new weight of items associated with each item.

In some implementations, the predicted categorizations generated by the ML categorization model 146 can be leveraged to ensure safety precautions for service providers or other people who may come in contact with the items. For example, based on the predicted categorizations generated by the ML categorization model 146, a delivery driver with a severe allergy to peanuts can be ensured to not be matched with delivering items that include peanuts. In particular, drivers can be matched with deliveries based at least in part on a combination of the predicted categorizations generated by the ML categorization model 146 and a driver profile. Even more particularly, the driver profile can be a data structure with a plurality of attributes. Furthermore, the plurality of attributes can be arranged in a look up table. The predicted categorizations output by the ML categorization model 146 can be used to perform a look up such that the computing system 100 can determine if there are any driver preferences, restrictions, or allergies that match. A similar type of analysis could be performed for any other individual or service provider that may come into contact with the delivery item (e.g., a human deliver facilitator at a centralized delivery location).

In some implementations, the predicted categorizations generated by the ML categorization model 146 can be associated with alcohol, items containing nicotine, or items otherwise requiring consumer identification in order to purchase. The computing system can surface a notification to the service provider when an order contains an item associated with requiring consumer identification so as to provide the service provider (e.g., delivery driver) a reminder to check the identification of the consumer prior to exchanging the items. Furthermore, the computing system can surface a notification to a user device associated with the service provider wherein the service provider can indicate via a user interface associated with the user device that they would like to reject being matched with a delivery (e.g., a delivery associated with a nicotine purchase). In particular, the computing system can also leverage the driver profile (e.g., via lookup) and automatically not consider particular service providers in the matching process. For example, if a delivery driver is under 21 years of age or has otherwise indicated that they would not like to be matched with deliveries including alcohol, the computing system can automatically not consider matching the driver with a delivery including alcohol.

In some implementations, the predicted categorizations generated by the ML categorization model 146 can be associated with weight or size of an item. For instance, the predicted categorizations generated by the ML categorization model 146 associated with weight or size of an item can be leveraged to match service providers with appropriate transportation to particular orders. For instance, the predicted categorizations can be associated with weight or size of an item associated with a particular delivery such that the computing system 100 can match a delivery driver with an appropriate transportation vehicle. By way of example, an order associated with picking up catering for a large party of people may be predicted by the ML categorization model 146 to exceed the space capacity of a small sedan. Thus, based at least in part on the predicted categorizations generated by the ML categorization model 146, the computing system 100 can predict that the order should be paired with a delivery driver with access to a larger vehicle.

In some implementations, the predicted categorizations generated by the ML categorization model 146 associated with weight or size of an item(s) can be leveraged to generate better predictions of bag fees. For example, without taking into consideration the weight and size of the requested items, the computing system 100 cannot accurately apply bag fees to the order. However, the computing system 100 can utilize the weight or size (e.g., based on the predictions of the ML categorization model 146) to determine how many, size, type, etc. bag(s) may be used to transport delivery item(s). Such information can be used to predict a bag fee to be applied to a particular order. For example, the computing system 100 can access one or more rules that can be used to calculate a bag fee based on the number, type, size, etc. of bags used for an order and a particular fee associated with a region (e.g., 5 cents per bag in City A).

In some implementations, the predicted categorizations generated by the ML categorization model 146 can be taken into account when determining batch orders. For instance, an item may be particularly conducive to being a part of batch orders (e.g., non-perishable items). On the other hand, another item may be particularly not conducive to being a part of batch orders (e.g., ice cream). Such information can be used to determine whether to batch certain items for coordinated delivery by a single service provider.

In some implementations, the output of the ML categorization model 146 can be associated with item temperature. For example, based on the output of the ML categorization model 146 the computing system 100 can batch cold items with other cold items or alternatively, the computing system can batch hot items with other hot items. Furthermore, the output of the ML categorization model 146 can be associated with a food being likely to melt. For example, based on the output of the ML categorization model 146 indicating that an item may melt, the computing system 100 can determine that the particular item is not a good candidate for including in a batch order. Additionally, or alternatively, as described herein, the output of the ML categorization model 146 can be associated with item size. In particular, based on the output of the ML categorization model 146 the computing system 100 can ensure that the items included in a batch order will fit within the spatial constraints associated with a particular service provider's transportation method. For example, the computing system 100 may batch an item considered large with additional items considered small based on a particular driver being associated with a small sedan as opposed to a different driver associated with a minivan. By leveraging the predicted categorizations generated by the ML categorization model 146, the computing system 100 can more effectively and efficiently determine whether to incorporate an order into a batch order or not.

In some implementations, the ML categorization model 146 can generate predicted nutritional statistics which can then be surfaced to the user. In particular, taxes based on nutritional statistics can be applied based on the predicted ML categorization model nutritional statistics (e.g., apply tax based on sugar content).

### Compliance Value Application

The network computing system 100 includes one or more program services 162, 164 which operate to augment, optimize or otherwise implement a particular facet or aspect of the network service (e.g., on demand transport and delivery) being provided through the network computing system. In some examples, the request handling component 128 retrieves labels 155 for items specified in an order request. The request handling component 128 provides labels 155 for a compliance program service (CPS) 162, which uses the labels of items in an order request 101 to calculate a compliance value for the order request 101. The compliance value can, for example, be in the form of a surcharge that is specified by a local, state or federal law. For example, local laws can specify (i) a type of deliverable item (e.g., soda) has an added surcharge when the item is sold in a particular region, or (ii) a food item has an additional surcharge when prepared hot or sold unheated. When an order request 101 is made, the CPS 162 can identify the labels 155 associated with the items of the order request 101, as well as the location 129 of the supplier, to query a surcharge calculation service for the surcharge value. The CPS 162 can associate a determined surcharge value for each item of an order request 101, such that when the charge for the order request 101 is made, the surcharge value for the additional items is automatically included and charged to the requester. Thus, for example, the local tax for soda purchase can be automatically applied to the invoice that is charged against the requester when the order request 101 is made.

The CPS 162 can receive the order from a requesting client device 102 and determine a compliance value 163 for the order, such as applicable taxes for each item. The CPS 162 can determine the compliance value by transmitting the compliance-sensitive labels 155 to a compliance calculation service (e.g., such as provided by a third party). The CPS 162 can provide the compliance calculation service with the data necessary for the compliance calculation service to determine one or more compliance values for an item. In the use case of determining a tax rate to apply to menu items, the data provided by the CPS 162 can include compliance-sensitive labels 155 of individual items of an order request 101, the location 129 of the supplier, and a type of the supplier (e.g., a fast food restaurant, coffee shop, bakery, etc.). In response, the compliance calculation service returns the determined compliance value(s) to the CPS 162. The transaction component 138 can apply the compliance value to determine the proper tax rates to the items in the order and charge the user accordingly. For example, the transaction component can apply a surcharge tax for certain items of the delivery order 121.

### Delivery Parameters and Application

As an addition or alternative, the network computing system 100 can include one or more delivery optimization program services (DOPS) 164 which use labels 155 associated with individual items of an order request 101 to optimize or otherwise facilitate one or more facets of the delivery process. In examples, DOPS 164 maps the labels 155 for individual items of order request 101 to one or more delivery parameters 165, which are then used to configure one or more delivery processes that are implemented by the network computing system 100, in connection with the delivery request 121 being fulfilled by the service provider.

In examples, the delivery parameters 165 include timing parameters. The timing parameters can indicate a threshold a range of time by which the service provider should complete a particular task connected with the delivery request. For example, in the context of food delivery, the timing parameter can set a threshold or range of time from with the service provider is expected to (i) arrive at the location of the supplier, and/or (ii) to deliver the food item to the delivery location.

The value of the timing parameters can be based on the labels 155 associated with the individual items of a delivery order 121. By way of example, if the delivery order 121 contains food items that are labeled as being the equivalent of “hot”, “prepared hot”, “deliver fresh”, “serve chilled”, the DOPS 164 can associate the label with a timing parameter that identifies a numeric range or threshold (e.g., pickup within 2 minutes). The delivery parameter 165 can be communicated as a timing value to the matching engine 140. The matching engine 140 can then implement a matching process where the timing value is used as a criterion or weight to select the service provider and/or the candidate set of service providers. For example, the matching engine 140 can exclude service providers from the candidate set if a determination is made that the service providers are likely to not be able to meet the threshold for picking up the delivery order or delivering the pickup order. As another example, the matching engine 140 can weight against selecting a candidate service provider if the determination is that the service provider is not likely to meet the threshold time for pickup or delivery, but would otherwise meet the criteria for other types of items. Still further, in another aspect, the timing parameters can be used to rank the candidate service providers. For example, the candidate service provider who can arrive at the pickup or delivery location the soonest may be ranked highest for matching with the delivery order.

As additional examples, the delivery parameters 165 can also result in the matching component 140 excluding service providers from the candidate set based on the service state 115 of the service provider. For example, if the service state 115 of the service provider indicates the service provider may need to complete another task or transport a passenger, the probability of the service provider being able to meet a timing parameter for the drop-off the delivery order 121 may be reduced. As a result, the matching component may exclude the service provider from selection, weight against selection of the service provider, or lower the rank of the service provider based on the service state 115 of the service provider.

In other examples, the delivery parameters 165 can identify a desired or required type of vehicle or equipment for a delivery order. The DOPS 164 can determine such type of delivery parameters when, for example, the labels 155 of the items indicate that the delivery order includes (i) one or more items of large dimensions, such as may be required with labels such as “bulky” or “large”; (ii) an item that requires or is preferred to be delivered in special packaging (e.g., insulated package for items that are labeled to indicate “prepared hot” or “serve chilled”; or dry ice for “keep cold”, etc.); and/or (iii) an item that requires or is preferred to be transported in a particular location of a vehicle (e.g., item labeled as “prepared alcoholic beverage” to be carried in vehicle trunk). In such examples, the delivery parameters can, for example, identify the type (e.g., SUV) or size of the vehicle used by individual service providers, the packaging the service provider carries in the vehicle (e.g., insulated bag, dry ice container), and/or the availability, size or configuration of different parts of the service provider's vehicle. In examples, the matching component 140 can query a provider profile store 148 (e.g., based on provider identifiers 111 of the provider data store 134) to determine which available service providers are suitable for the delivery order. For example, service providers can associate key words or tags with their respective profile, where the key words or tags match the delivery parameters 165 which are determined by the DOPS 164. In this way, the matching component 140 can implement a matching process that selects, weights and/or ranks available service providers based on the delivery parameters 165 relating to vehicle type or equipment.

Still further, in examples, the delivery parameters 165 can identify a required or preferred characteristic of a service provider. The DOPS 164 can determine such type of delivery parameters 165 when, for example, the labels 155 of the items indicate that (i) the delivery order includes a legal requirement for the service provider (e.g., age requirement for service provider when label identifies “alcoholic beverage”), and/or (ii) the delivery order includes a label that identifies a particular characteristic which may be against a preference of the service provider (e.g., label 155 indicates item is “heavy”). In such examples, the matching component 140 can query a provider profile store 148 to determine relevant characteristics of service providers, as indicated by the delivery parameters 165. For example, the matching component 140 can query the provider profile store 148 to determine if a candidate service provider satisfies an age requirement specified by the delivery parameter 165. Similarly, the matching component 140 can query the provide profile store 148 to determine whether a candidate service provider has a preference against carrying an item that is heavy, as specified by the delivery parameters 165 of the order request 121.

Further, the provider profile store 148 can include profile information that is determined by the network computing system 100, based on, for example, the historical performance of the service provider. For example, the network computing system 100 can include implement monitoring processes that evaluate the skill of the service provider in driving evenly and/or in a timely fashion. Based on the label 155 (e.g., “delicate food item”), the matching component 140 can query the provider profile store 148 to identify candidate service providers who are more likely to drive evenly and expeditiously for the particular item.

### Methodology

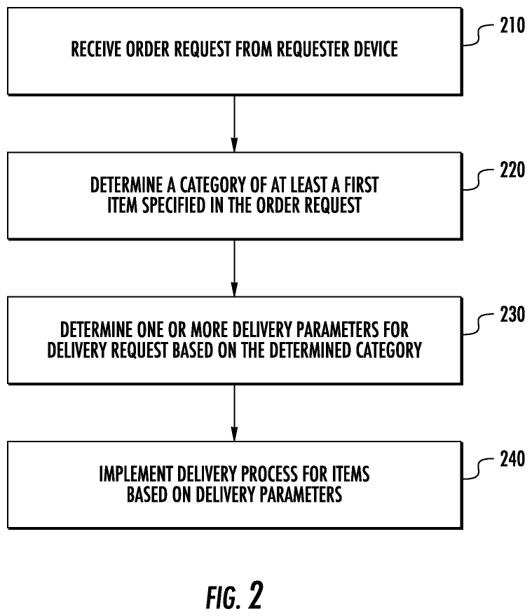

FIG. 2 illustrates an example method for configuring a delivery process based on a determined categorization of one or more items of a delivery order. FIG. 3 illustrates for programmatically categorizing a deliverable item based on a supplier's description of the item. While operations of methods described with FIG. 2 and FIG. 3 are described below as being performed by a network computing system of FIG. 1, it will be appreciated that these operations need not necessarily be performed by the specific components identified and could be performed by a variety of components and modules, potentially distributed over a number of machines. Accordingly, references may be made to elements of network computing system 100 for purpose of illustrating suitable components or elements for performing a step or sub step being described. It will also be appreciated that some of the steps of example methods as described may be performed in parallel or in a different order than illustrated.

At block 210, network computing system 100 receives order request 101 from a requester device 102. The order request 101 specifies one or more items that are provided by a supplier, as well as a delivery location where the one or more items are to be delivered. The requester can specify the order request 101 by operating requester device 102, executing service application 106, to access a delivery service provided by the network computing system 100. As an example, the requester use the service application 116 to view and select from menus of nearby restaurants which prepare food items for delivery to consumers. As another example, the requester can use the service application 116 to view and select from product catalogs of nearby merchants, to view and select merchandise which the requester can have delivered. The delivery location can be determined from a current location of the requester. For example, the service application can execute on the requester device to obtain and transmit the current location of the requester. Alternatively, the requester can specify an alternative location, through, for example, preselection of a favorite location (e.g., the user's home) or manual entry of an address.

At block 220, the network computing system 100 determines a category of at least a first item specified in the order request, where the category is determined programmatically based at least in part on a description provided by the supplier of the first item. In examples, the items which the requester views and selects are associated with predetermined labels, where each label identifies a corresponding category that is programmatically determined for the item by the network computing system 100. The network computing system 100 may implement batch processes to process supplier records (e.g., menus or product catalogs), including to programmatically categorize individual items for one or more suppliers. Upon receiving the order request, network computing system 100 identifies the label(s) associated with individual items of the order request. As an addition or variation, in response to receiving the order request, the network computing system 100 programmatically analyzes the description of individual items of the order request to determine a category for at least one item. Thus, in such examples, the network computing system 100 can, as a response to receiving the order request, programmatically analyze a description of the item provided by a supplier to determine a category (or label) for an item of the order request.

In examples, the determined category can indicate or identify transport-related attributes of the item, such as a temperature, size and/or quantity of an item identified by the order request. The determined category can indicate, for example, a temperature of the item at the time of pickup and/or a desired temperature of the item when delivered. Still further the characterization of the temperature can reflect a range of temperature values, such as “hot”, “heated”, “unheated”, “cold”, “frozen”, etc.

As an addition or variation, the determined category can indicate a range of dimensional sizes, such as “extra-large”, “large”, “medium”, “small”, etc. As an addition or variation, the determined category can indicate an amount of space which the transport vehicle may require for delivery, such as “extra bulky” or “bulky”. As another addition or variation, the determined category can indicate the type of space which may be required to deliver the item, such as “trunk”, “back row” or “single seat”.

Still further, in other examples, the determined category can reflect a weight of an item of the delivery order. For example, the category can reflect that the weight of a delivered item may exceed a threshold marker for “heavy” (e.g., 50 lbs.).

In other variations, the category of an item can reflect a quantity. For example, an item which is actually a package of multiple items (e.g., 12 pack of soda cans) can be categorized to reflect the quantity of individual items and/or the total quantity of product which is provided with the item (e.g., total number of fluid ounces).

As an addition or variation, the determined category of the item can reflect items which require special-handling. By way of example, items which require special-handling can include items which are fragile to delivery conditions (e.g., easily defaced, broken or diminished by movement), and/or items which may require a particular type of environment for transport. To illustrate, a frozen dessert may be categorized to indicate that a cooler or insulated container may be required for its delivery.

Still further, in some examples, the determined category can identify items which may be subject to special delivery rules. For example, the determined category can identify items which contain alcohol and are subject to specific delivery rules based on ordinances or state laws. Additionally, the predetermined category can identify attributes of the item which make the item subject to alternative rules, ordinances or laws. For example, the category can distinguish between a corked wine bottle and a prepared cocktail. The attributes that are associated with individual categories can be geographic-specific, based on ordinances, regulations, or other rules that apply to a particular geographical region.

In other variations, the determined category can identify products which are potentially harmful to some consumers. For example, the determined category can identify a product which contains a suspected carcinogen, a potential allergen (e.g., peanuts) or an ingredient that is potentially harmful (e.g., raw eggs, alcohol).

At block 230, the network computing system 100 determines one or more delivery parameters for a delivery request 121 based on the determined category of at least one item. The delivery parameter can indicate a condition or attribute(s) of at least one item in the order from which a process for delivering the item is altered or adapted, as compared to a default process or a delivery process for another item. In examples, delivery parameters can include timing parameters, such as (i) a desired time of pickup of the one or more items from the supplier, and/or (ii) a desired time of delivery of the one or more items at the delivery location. In variations, the delivery parameter can identify a vehicle type (e.g., large, extra trunk space, small with no trunk space, etc.) for the service provider making the delivery, and/or particular equipment or capability (e.g., cooler, restrained carrying box, etc.) that is available with the vehicle used to make the delivery. Still further, the delivery parameter can identify a skill or experience level of the service provider (e.g., experienced or highly-rated versus on-probation; slow or careful versus speedy driver).

As an addition or variation, the delivery parameter can identify a carrying weight of the service provider. For example, the service provider may have a preference or setting which indicates that the provider cannot carry items that are heavy or bulky. Still further, the delivery parameter can identify an expected status of the service provider when making the delivery. For example, the expected status of the service provider during the delivery can indicate whether or not the service provider is expected to also transport a human passenger. Still further, the delivery parameter can specify a requisite age or other characteristic of the service provider. Additionally, the delivery parameter can identify drop-off requirements for the service provider.

At block 240, a delivery process to deliver items of the order request is implemented based on the one or more delivery parameters. According to examples, the implementation of the delivery process can be configured or otherwise impacted by one or more delivery parameters which are based on the determined category of at least one item of the order request. In examples, the determined delivery parameter(s) for a given order request can affect, for example, (i) a matching process where a service provider is matched to an order request, (ii) a preparation process, where a supplier of an item is instructed to prepare a delivery order, and/or (iii) a handling process, where a selected service provider is instructed to pickup and deliver the items of an order request.

With regards to the matching process, the determined delivery parameter(s) can specify additional criteria for active service providers to be identified as a candidate for the order request, meaning an otherwise suitable service provider is excluded from the pool of drivers that can be matched to the order request if the service provider cannot meet a condition of the delivery parameter. As another aspect, the determined delivery parameter can weight or rank candidate service providers, meaning a service provider that can meet a condition of the determined delivery parameter is more likely to be selected as the service provider for the order request.

In examples in which the delivery parameter is a timing parameter, the selection of the service provider may be based in part on a determination that the service provider is able to pick up the items of the order request from the supplier by the desired time of pickup, and/or deliver the one or more items to the delivery location by the desired time of delivery. For example, the ability of the service provider to meet the desired time of pickup and/or desired time of delivery can provide an additional requirement in selecting the service provider, weight the selection of the service provider, factor in ranking the service provider relative to other service providers for selection of the particular order request.

In other examples, the delivery parameter can specify a profile-related parameter, such as a capability (e.g., based on vehicle or equipment) or preference of the service provider. By way of example, for individual service providers, the service provider matching process can include a determination that the profile information for the service provider indicates the service provider operates a vehicle having a capability (e.g., based on vehicle type or equipment) that is required or preferred for the order request, based on the delivery parameter. In one implementation, service providers that cannot meet the requirement indicated by the delivery parameter may be excluded from being considered as a candidate to match with the order request. In variations, service providers that satisfy a condition of the delivery parameter can be favored (e.g., by weighting or ranking) for being matched to the order request.

In variations, the service matching process can include a determination that the preference of individual service providers (e.g., as indicated by the profile information) is against carrying an item that, for example, exceeds a particular weight or dimension. Accordingly, the service provider matching process can implement criteria, weighting or ranking based on the preference of individual service providers satisfying (or not) the condition indicated by the delivery parameter. Still further, the delivery parameter can specify other requirements for the service provider. For example, the delivery parameter can specify an age for the service provider, based on the category of an item in the delivery being categorized as an “alcoholic beverage”.

In some examples, the delivery parameter can affect the preparation process. For example, the network computing system 100 can transmit instructions to a supplier or service provider (e.g., service provider who gathers the delivery items from a store) as to how a delivery item is to be packaged, carried or transported. For example, if one of the items being picked up is deemed to be “hot” or “cold”, the delivery parameter can specify insulated packaging to transport the item, and the item may be packaged accordingly by the supplier or service provider before transport is initiated.

Additionally, in some examples, the delivery parameter can affect a handling process, such as when the delivery item is delivered. For example, the delivery parameter can identify a specific activity which the service provider must perform when delivering the delivery order. In some geographic regions, for example, if the determined category of the delivery items includes an alcoholic beverage, the service provider may be required to drop-off the delivery item with a person who is of a particular age.

With reference to an example of FIG. 3, at block 310, raw text that describes deliverable items of a supplier is obtained from a supplier resource. The supplier resource can correspond to, for example, an electronic document (e.g., menu or product catalog), or a record of items provided by the supplier. In the context of a restaurant menu, the raw text can include a description of an individual item. The raw text can also include a contextual description of the item, where the contextual description applies to multiple items on the menu (e.g., menu sections labeled as “breakfast”, “lunch”, “dinner”, “entrees”, “side dishes”, etc.).

At block 320, raw text is tokenized to generate a list of descriptive words, where the list of words disregard grammar and word order but retain multiplicity. In some aspects, the description processor compares each of the word tokens to a list of stop words and removes any word tokens that are found in the list of stop words. Stop words can include common words in the language of the description, such as articles and prepositions, as well as keywords that may appear in the raw text of catalogued items. To illustrate, keywords can include field names and headings such as “menu,” “name,” and “description.” In an example shown by FIG. 3, once the stop words are removed, the resulting list of descriptive words 320 contains [breakfast, toasted, bagel, choice, plain, sesame, everything, whole, wheat, bagel].

At block 330, the list of descriptive words are used as input to a custom-trained natural language processing (NLP) model to generate custom-trained word embeddings. In some examples, a group of related models that are used to produce word embeddings. For example, a shallow, two-layer neural network model can be trained to reconstruct linguistic contexts of words. Such models can utilize, as input, a large corpus of text to produce a vector space, typically of hundreds or thousands of dimensions, with each unique word in the corpus being assigned a corresponding vector in the space. Word vectors are positioned in the vector space such that words that share common contexts in the corpus are located close to one another in the space. In the context of restaurants, items across menus can be used as the corpus for training input for the NLP model to generate and update the vector space.

To generate the custom-trained word embeddings, each word in the list of descriptive words is matched to its corresponding vector in the NLP model, and the resulting vectors are combined (e.g., by averaging values at each index). The resulting custom-trained word embedding is a single vector numeric representation of the description of the item.

At block 340, the custom-trained word embeddings provide categorical definitions for categorizing the same or similar items in future delivery requests. In some examples, word-embeddings that are determined from a first supplier can be used to categorize items from multiple suppliers on future delivery requests. As described with an example of FIG. 1 and elsewhere, the network computing system 100 can generate labels 155 as an output of the categorization subsystem 150, where each label reflects a category definition provided by a corresponding word-embedding.

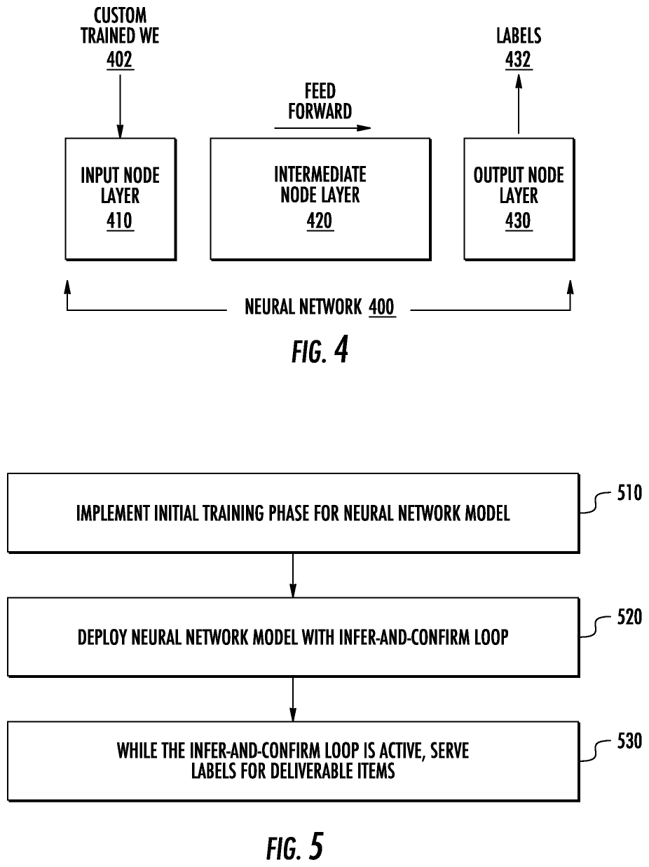

FIG. 4 illustrates an example of a machine-learning neural network model to categorize an item based on a numeric representation of its description. In an example shown, a neural network model 400 includes an input node layer 410, an intermediate node layer 420, and an output node layer 430. In the input node layer 410, the neural network model 400 takes custom-trained word embeddings 402 as input. As described below, the intermediate layer 420 can implement modeling functions to generate categorizations or labels 432 from the output stage 430.

The neural network model 400 can be based on a collection of connected units or nodes, sometimes referenced as artificial neurons based on a loose correlation to neurons in a biological brain. Each connection, like the synapses in a biological brain, can transmit a signal to other neurons. An artificial neuron that receives a signal then processes it and can signal neurons connected to it. The “signal” at a connection is a real number, and the output of each neuron is computed by some non-linear function of the sum or combination of its inputs. The connections are called edges. Neurons and edges typically have a node weight that is determined and adjusted through learning (or training) processes. The node weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the input node layer 410 to the output node layer 430, after traversing the intermediate node layer 420.

In examples, the neural network model 400 can be implemented as a feed-forward neural network. In this type of neural network model, information moves in only one direction—forward—from the nodes of the input layer, through hidden nodes of the intermediate layer(s) 420, and to nodes of the output layer 430, without cycles or loops in the network. Although a feed-forward neural network is shown as one example of FIG. 4, other types of machine- or deep-learning categorization models can be implemented. As examples, a machine-learning categorization modeler can be implemented as a convolutional neural network, radial basis network, etc.

For a given node of the neural network model 400, the inputs are multiplied by the respective node weight and summed together. This value may be referred to as the summed activation of the node. The summed activation can be transformed via an activation function to define the specific output or “activation” of the node. Thus, the activation function is responsible for transforming the summed weighted input from the node into the activation of the node or output of that node.

In some aspects, the neural network model 400 uses a rectified linear activation function (ReLu) for its activation function. The ReLu function is a piecewise linear function that outputs the input directly if it is positive, otherwise, it outputs zero. The ReLu function can provide a default activation function for the neural network model, as it is relatively easy to train and often achieves better performance. However, other types of activation functions, such as sigmoid and hyperbolic tangent, can be used instead of ReLu.

The output node 430 of the neural network model can generate a set of probabilities for determined categories or labels 432. In some aspects, the neural network model performs joint learning to be able to classify an item across multiple categorization schemes 430. For example, the feed-forward network shown in FIG. 4 can classify an item into one of twenty-five categories and one of three temperature categories (e.g., heated, unheated, cold). In some examples, the determined labels 432 can be applied to specific items of a supplier, along with a confidence value associated with the determination of the label. As described with an example of FIG. 5, the confidence values of items can trigger manual or second review, from which further training and model tuning can take place.

In examples, the neural network model 400 generate labels based on a predetermined category schema. In some implementations, multiple categorical schemas can be used to obtain parallel categorization results for different domains.

FIG. 5 illustrates an example method of training a machine-learning neural network model, such as described with FIG. 4. Reference is made to examples of FIG. 1 and FIG. 4 for purpose of illustrating a component or element to implement a step or sub-step being described.

At block 510, an initial training phase is implemented for neural network model 400. In the context of menu item categorization, the network computer system presents data for an item to a human for manual classification. The data can include any fields that the natural language processor may use to generate a numeric representation of the menu item, including the item's name and textual description. Through a series of questions presented to a human classifier, the network computing system 100 assigns one or more categories to an item, where the available categories are predetermined for use in a particular domain (e.g., for delivery parameters or determining compliance charges). The network computing system 100 can develop neural network model 400 based on the initial data that includes items and manually identified categories.

At block 520, network computer system 100 deploys the model and implements an infer-and-confirm loop to update and tune the model. While the infer-and-confirm loop is active, the neural network model 400 also serves labels for deliverable items (430). In one aspect, the model categorizes items and stores the labels 155 in the supplier data store 126, in association with respective records of items from a corresponding supplier.

To update and tune the model, network computing system 100 can stage surveys (e.g., interfaces that prompt a user for a yes/no response) for users, operators, or quality checkers for purpose of adapting the neural network model 400. The categorization subsystem 150 can, for example, generate confidence value for individual labels 155 which it generates. When the confidence value for a given label 155 is below a threshold, the network computing system 100 queues the item and its determined label 155 for checking. A quality checker may be presented a survey or other interface that shows the item and the determined label, and the quality checker can provide input that indicates the person agrees or disagrees with the determined label 155. The network computing system 100 uses the input of the quality checker to update the neural network model 400 based on the correctness of the label 155.

### Computer System

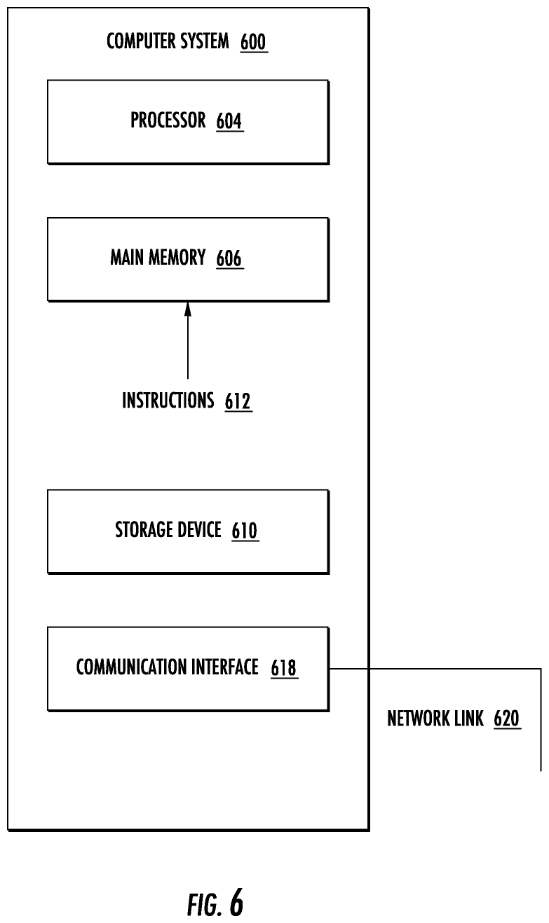

FIG. 6 is a block diagram that illustrates a computer system upon which aspects described herein may be implemented. For example, in the context of FIG. 1, the network computing system 100 and categorization subsystem 150 can be implemented using one or more servers such as described by FIG. 6.

In an aspect, computer system 600 includes processor 604, memory 606 (including non-transitory memory), storage device 610, and communication interface 618. Computer system 600 includes at least one processor 604 for processing information. Computer system 600 also includes the main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. The storage device 610, such as a magnetic disk or optical disk, is provided for storing information and instructions. The communication interface 618 may enable the computer system 600 to communicate with one or more networks through use of the network link 620 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 600 for implementing the techniques described herein. According to one aspect, those techniques are performed by computer system 600 in response to processor 604 executing one or more sequences of one or more instructions 612 contained in main memory 606. Such instructions 612 may be read into main memory 606 from another machine-readable medium, such as storage device 610. Execution of the sequences of instructions contained in main memory 606 causes processor 604 to perform the process steps described herein, including processes described with examples of FIG. 2 through FIG. 5. In alternative aspects, hard-wired circuitry may be used in place of or in combination with software instructions to implement aspects described herein. Thus, aspects described are not limited to any specific combination of hardware circuitry and software.

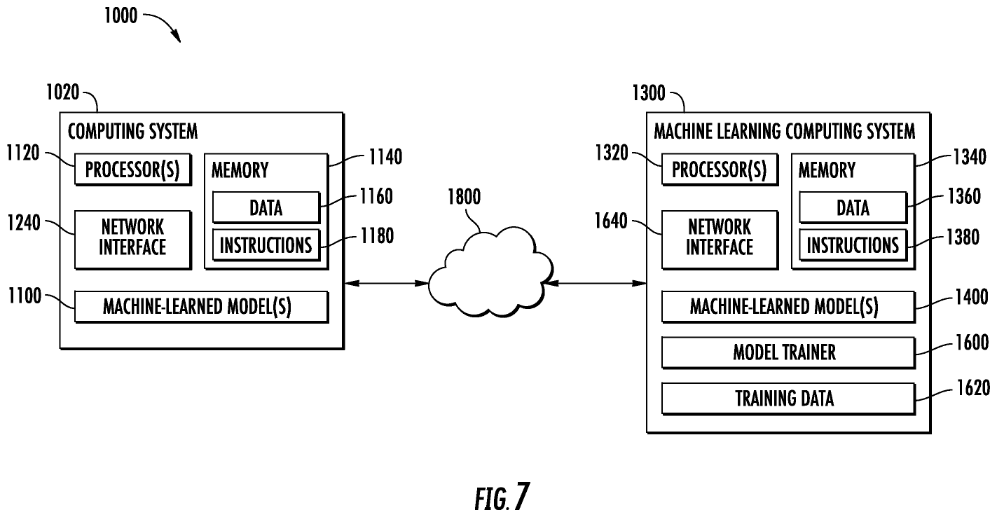

FIG. 7 depicts a block diagram of an example computing system 1000 according to example embodiments of the present disclosure. The example system 1000 includes a computing system 1020 and a machine learning computing system 1300 that are communicatively coupled over a network 1800.

In some implementations, the computing system 1020 can perform a matching service in which transport is arranged to deliver requested items for requesters. In some implementations, the computing system 1020 can be included in a vehicle. For example, the computing system 1020 can be on-board an autonomous vehicle or can be a computing system associated with a driver. In other implementations, the computing system 1020 is not located on-board the autonomous vehicle. For example, the computing system 1020 can operate offline to perform a matching service in which transport is arranged to deliver requested items for requesters. In some implementations, the computing system 1020 can represent a user computing system associated with a user. The computing system 1020 can include one or more distinct physical computing devices.

The computing system 1020 includes one or more processors 1120 and a memory 1140. The one or more processors 1120 can be any suitable processing device (e.g., a processor core, a microprocessor, an ASIC, a FPGA, a controller, a microcontroller, etc.) and can be one processor or a plurality of processors that are operatively connected. The memory 1140 can include one or more non-transitory computer-readable storage media, such as RAM, ROM, EEPROM, EPROM, one or more memory devices, flash memory devices, etc., and combinations thereof.

The memory 1140 can store information that can be accessed by the one or more processors 1120. For instance, the memory 1140 (e.g., one or more non-transitory computer-readable storage mediums, memory devices) can store data 1160 that can be obtained, received, accessed, written, manipulated, created, and/or stored. The data 1160 can include, for instance, d any of the data or information described herein. In some implementations, the computing system 1020 can obtain data from one or more memory device(s) that are remote from the system 1020.

The memory 1140 can also store computer-readable instructions 1180 that can be executed by the one or more processors 1120. The instructions 1180 can be software written in any suitable programming language or can be implemented in hardware. Additionally, or alternatively, the instructions 1180 can be executed in logically and/or virtually separate threads on processor(s) 1120.

For example, the memory 1140 can store instructions 1180 that when executed by the one or more processors 1120 cause the one or more processors 1120 to perform any of the operations and/or functions described herein, including, for example, perform any of the functions of the computing systems and devices (e.g., of FIGS. 1 and 6), any of the operations/steps of any of the methods or processes described herein including those of FIGS. 2, 3, and 5, and/or any other operations or functions.

According to an aspect of the present disclosure, the computing system 1020 can store or include one or more machine-learned models 1100. As examples, the machine-learned models 1100 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

In some implementations, the computing system 1020 can receive the one or more machine-learned models 1100 from the machine learning computing system 1300 over network 1800 and can store the one or more machine-learned models 1100 in the memory 1140. The computing system 1020 can then use or otherwise implement the one or more machine-learned models 1100 (e.g., by processor(s) 1120). In particular, the computing system 1020 can implement the machine learned model(s) 1100 to perform a matching service in which transport is arranged to deliver requested items for requesters.

The machine learning computing system 1300 includes one or more processors 1320 and a memory 1340. The one or more processors 1320 can be any suitable processing device (e.g., a processor core, a microprocessor, an ASIC, a FPGA, a controller, a microcontroller, etc.) and can be one processor or a plurality of processors that are operatively connected. The memory 1340 can include one or more non-transitory computer-readable storage media, such as RAM, ROM, EEPROM, EPROM, one or more memory devices, flash memory devices, etc., and combinations thereof.

The memory 1340 can store information that can be accessed by the one or more processors 1320. For instance, the memory 1340 (e.g., one or more non-transitory computer-readable storage mediums, memory devices) can store data 1360 that can be obtained, received, accessed, written, manipulated, created, and/or stored. The data 1360 can include, for instance, any of the data or information described herein. In some implementations, the machine learning computing system 1300 can obtain data from one or more memory device(s) that are remote from the system 1300.

The memory 1340 can also store computer-readable instructions 1380 that can be executed by the one or more processors 1320. The instructions 1380 can be software written in any suitable programming language or can be implemented in hardware. Additionally, or alternatively, the instructions 1380 can be executed in logically and/or virtually separate threads on processor(s) 1320.

For example, the memory 1340 can store instructions 1380 that when executed by the one or more processors 1320 cause the one or more processors 1320 to perform any of the operations and/or functions described herein, including, for example, predict categorizations.

In some implementations, the machine learning computing system 1300 includes one or more server computing devices. If the machine learning computing system 1300 includes multiple server computing devices, such server computing devices can operate according to various computing architectures, including, for example, sequential computing architectures, parallel computing architectures, or some combination thereof.

In addition or alternatively to the model(s) 1100 at the computing system 1020, the machine learning computing system 1300 can include one or more machine-learned models 1400. As examples, the machine-learned models 1400 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

As an example, the machine learning computing system 1300 can communicate with the computing system 1020 according to a client-server relationship. For example, the machine learning computing system 1400 can implement the machine-learned models 1400 to provide a web service to the computing system 1020. For example, the web service can provide further data which can be associated with items requested for delivery.

Thus, machine-learned models 1100 can located and used at the computing system 1020 and/or machine-learned models 1400 can be located and used at the machine learning computing system 1300.

In some implementations, the machine learning computing system 1300 and/or the computing system 1020 can train the machine-learned models 1100 and/or 1400 through use of a model trainer 1600. The model trainer 1600 can train the machine-learned models 1100 and/or 1400 using one or more training or learning algorithms. One example training technique is backwards propagation of errors. In some implementations, the model trainer 1600 can perform supervised training techniques using a set of labeled training data. In other implementations, the model trainer 1600 can perform unsupervised training techniques using a set of unlabeled training data. The model trainer 1600 can perform a number of generalization techniques to improve the generalization capability of the models being trained. Generalization techniques include weight decays, dropouts, or other techniques.

In particular, the model trainer 1600 can train a machine-learned model 1100 and/or 1400 based on a set of training data 1620. The training data 1620 can include, for example, the manual corrections and confirmations which are stored with the supplier data store as well as labeled data (e.g., categories associated with items) and/or other training data such as the examples described herein. The model trainer 1600 can be implemented in hardware, firmware, and/or software controlling one or more processors.

The computing system 1020 can also include a network interface 1240 used to communicate with one or more systems or devices, including systems or devices that are remotely located from the computing system 1020. The network interface 1240 can include any circuits, components, software, etc. for communicating with one or more networks (e.g., 1800). In some implementations, the network interface 1240 can include, for example, one or more of a communications controller, receiver, transceiver, transmitter, port, conductors, software and/or hardware for communicating data. Similarly, the machine learning computing system 1300 can include a network interface 1640.

The network(s) 1800 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 1800 can be accomplished, for instance, via a network interface using any type of protocol, protection scheme, encoding, format, packaging, etc.

FIG. 7 illustrates one example computing system 1000 that can be used to implement the present disclosure. Other computing systems can be used as well. For example, in some implementations, the computing system 1020 can include the model trainer 1600 and the training dataset 1620. In such implementations, the machine-learned models 1100 can be both trained and used locally at the computing system 1020. As another example, in some implementations, the computing system 1020 is not connected to other computing systems.

In addition, components illustrated and/or discussed as being included in one of the computing systems 1020 or 1300 can instead be included in another of the computing systems 1020 or 1300. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A computer system comprising:
one or more processors; and
one or more memory resources storing instructions that, when executed by the one or more processors, cause the computer system to perform operations including:
receiving an order request from a requester, the order request specifying one or more items provided by a supplier and a delivery location;
determining, using a machine-learning categorization model, a category of at least a first item specified in the order request, the machine-learning categorization model being trained to determine the category based at least in part on a description of the first item;
determining one or more delivery parameters for the order request based on the determined category of at least the first item; and
based at least in part on the one or more delivery parameters for the order request, implementing a delivery process that includes selecting a service provider that delivers the one or more items of the order request to the delivery location.

2. The computing system of claim 1, wherein the operations further comprise:
processing a menu or catalog of the supplier to identify a set of words that are used to describe each of one or more items, including the first item;
generate a numeric representation of the of words of each of the one or more items; and
for each of the one or more items, determine at least one of a plurality of categories for the item based at least in part on the numeric representation.

3. The computing system of claim 2, wherein determining at least one of the plurality of categories includes using the numeric representation as input to a machine-learning categorization model that generates a value corresponding to the at least one category determined for each item.

4. The computing system of claim 3, wherein the machine-learning categorization model associates each category of the plurality of categories with a corresponding numeric representation, and wherein determining the at least one category of the plurality of categories for each of the one or more items includes comparing the numeric representation of each of the one or more items with the numeric representation of one or more categories of the plurality categories.

5. The computing system of claim 4, wherein determining each category of the plurality of categories is associated with one or more attributes, and wherein the one or more delivery parameters for the first item is based at least in part on an attribute associated with the determined category.

6. The computing system of claim 5, wherein the attribute is indicative of at least one of a temperature, a size or a quantity of the item.

7. The computing system of claim 1, wherein the determined category is indicative of at least one of a temperature, a size or a quantity of the item.

8. The computing system of claim 1, wherein determining the one or more delivery parameters includes determining, based on the determined category of at least the first item, a timing parameter that is indicative of at least one of (i) a desired time of pickup of the one or more items from the supplier, or (ii) a desired time of delivery of the one or more items at the delivery location.

9. The computing system of claim 8, wherein implementing the delivery process includes selecting the service provider based at least in part on a determination that the service provider is able to (i) pickup of the one or more items from the supplier by the desired time of pickup, or (ii) deliver the one or more items to the delivery location by the desired time of delivery.

10. The computing system of claim 9, wherein selecting the service provider based at least in part on the determination includes determining a current location of the service provider.

11. The computing system of claim 10, wherein selecting the service provider based at least in part on the determination includes determining a status of the service provider.

12. The computing system of claim 1, wherein determining the one or more delivery parameters includes determining, based on the determined category of at least the first item, an environmental parameter that is indicative of a desired environment for transporting at least the first item, and wherein selecting the service provider includes selecting the service provider based at least in part on delivery equipment used by the service provider.

13. A method for operating a network computer system, the method being implemented by one or more processors and comprising:
receiving an order request from a requester, the order request specifying one or more items provided by a supplier and a delivery location;
determining, using a machine-learning categorization model, a category of at least a first item specified in the order request, the machine-learning categorization model being trained to determine the category based at least in part on a description of the first item;
determining one or more delivery parameters for the order request based on the determined category of at least the first item; and
based at least in part on the one or more delivery parameters for the order request, implementing a delivery process that includes selecting a service provider that delivers the one or more items of the order request to the delivery location.

14. The method of claim 13, further comprising:
processing a menu or catalog of the supplier to identify a set of words that are used to describe each of one or more items, including the first item;
generate a numeric representation of the of words of each of the one or more items; and
for each of the one or more items, determine at least one of a plurality of categories for the item based at least in part on the numeric representation.

15. The method of claim 14, wherein determining at least one of the plurality of categories includes using the numeric representation as input to a machine-learning categorization model that generates a value corresponding to the at least one category determined for each item.

16. The method of claim 15, wherein the machine-learning categorization model associates each category of the plurality of categories with a corresponding numeric representation, and wherein determining the at least one category of the plurality of categories for each of the one or more items includes comparing the numeric representation of each of the one or more items with the numeric representation of one or more categories of the plurality categories.

17. The method of claim 16, wherein determining each category of the plurality of categories is associated with one or more attributes, and wherein the one or more delivery parameters for the first item is based at least in part on an attribute associated with the determined category.

18. The method of claim 17, wherein the attribute is indicative of at least one of a temperature, a size or a quantity of the item.

19. The method of claim 13, wherein the determined category is indicative of at least one of a temperature, a size or a quantity of the item.

20. A non-transitory computer-readable medium that stores instructions, executable by one or more processors, to cause the one or more processors to perform operations including:
receiving an order request from a requester, the order request specifying one or more items provided by a supplier and a delivery location;
determining a category of at least a first item specified in the order request, the category being determined programmatically based at least in part on a description of the first item;
determining one or more delivery parameters for the order request based on the determined category of at least the first item; and
based at least in part on the one or more delivery parameters for the order request, implementing a delivery process that includes selecting a service provider that delivers the one or more items of the order request to the delivery location.
